(19) United States
(12) Patent Application Publication
(10) Pub. No.: US 2025/0076558 A1
(43) Pub. Date: Mar. 6, 2025

(54) Waveguide Display with Air Cushion

(71) Applicant: Apple Inc., Cupertino, CA (US)

(72) Inventors: Alexander D Schlaupitz, Longmont, CO (US); Hao Dong, San Jose, CA (US); Jian Cheng, Hayward, CA (US)

(21) Appl. No.: 18/791,208

(22) Filed: Jul. 31, 2024

Related U.S. Application Data
(60) Provisional application No. 63/580,311, filed on Sep. 1, 2023.

(51) Int. Cl. F21V 8/00; G02B 27/01

(52) U.S. Cl. CPC G02B 6/0016; G02B 6/0021; G02B 6/0083; G02B 6/0095; G02B 27/0101

(57) ABSTRACT

An electronic device may include a display having a waveguide that propagates image light and having optics such as a tint layer or bias lens mounted to the waveguide by a ring of adhesive. The ring may laterally surround an air cavity between the optics and the waveguide. A surface relief grating may be mounted to the waveguide within the air cavity. One or more air flow channels may be provided in the ring of adhesive and/or the optics to constrain air flow out of the air cavity on the time scale of a drop or impact event. This may configure the air cavity to maintain its volume during the event, effectively forming an air cushion for components in the air cavity. The air flow channels may pass air between the air cavity and the environment on the time scale of environmental ambient pressure changes.

This application claims the benefit of U.S. Provisional Patent Application No. 63/580,311, filed Sep. 1, 2023, which is hereby incorporated by reference herein in its entirety.

### BACKGROUND

This disclosure relates to optical systems such as optical systems in electronic devices having displays.

Electronic devices can include displays that provide images near the eyes of a user. Such electronic devices often include virtual or augmented reality headsets with displays having optical elements that allow users to view the displays.

If care is not taken, external forces such as impacts or drop events can cause optical components in the displays to become misaligned or damaged, preventing the displays from exhibiting sufficient levels of performance.

### SUMMARY

An electronic device may include a display. The display may include a projector that emits image light and a waveguide that propagates the image light via total internal reflection. The display may include optics mounted to the waveguide by a ring of adhesive. The optics may transmit world light to the waveguide. The optics may include a tint layer or a bias lens, as examples. The ring of adhesive may laterally surround an air cavity between the optics and the waveguide. A surface relief grating may be mounted to the waveguide within the air cavity. The surface relief grating may diffract the image light out of the waveguide and towards an eye box. The surface relief grating may transmit the world light to the eye box.

The display may include one or more air flow channels from the air cavity to the surrounding environment. The air flow channels may extend through the ring of adhesive and/or may extend through one or more layers of the optics. The air flow channels may be configured to constrain air flow out of the air cavity on the relatively short time scale of an external force applied to the display, such as a drop or impact event. This may configure the air cavity to maintain its volume or minimize its volume change while the external force is applied, effectively forming an air cushion for optical components within the air cavity. The air flow channels may be configured to pass air between the air cavity and the surrounding environment on the relatively long time scale of ambient pressure changes in the surrounding environment.

### BRIEF DESCRIPTION OF THE DRAWINGS

FIG. 1 is a diagram of an illustrative system having a display in accordance with some embodiments.

FIG. 2 is a top view of an illustrative display having a waveguide with optics for providing a virtual object overlaid with a real-world object to an eye box in accordance with some embodiments.

FIG. 3 is a cross-sectional top view of an illustrative display having a waveguide and optics separated from the waveguide by an air cavity in accordance with some embodiments.

FIG. 4 is a front view showing how an illustrative display of the type shown in FIG. 3 may be provided with air flow channels that pass air between an air cavity and the surrounding environment in accordance with some embodiments.

FIG. 5 is a cross-sectional top view of an illustrative display having an air flow channel in a peripheral edge seal between a waveguide and optics mounted to the waveguide in accordance with some embodiments.

FIGS. 6 and 7 are cross-sectional side views showing how illustrative air flow channels may be formed in different layers of a peripheral edge seal in accordance with some embodiments.

FIG. 8 is a cross-sectional side view showing how an illustrative air flow channel may be formed from a layer of open cell foam in a peripheral edge seal in accordance with some embodiments.

FIG. 9 is a cross-sectional side view showing how an illustrative air flow channel may be provided with a flexible printed circuit extending through the air flow channel in accordance with some embodiments.

FIG. 10 is a cross-sectional side view showing how an illustrative air flow channel may be formed from one or more hollow tubes in a peripheral edge seal in accordance with some embodiments.

FIG. 11 is a front view showing how an illustrative air flow channel may follow a meandering path through a peripheral edge seal in accordance with some embodiments.

FIGS. 12 and 13 are cross-sectional top views of an illustrative display having an air flow channel formed from an opening in one or more layers of optics mounted to a waveguide in accordance with some embodiments.

FIG. 14 is a cross-sectional top view of an illustrative air flow channel formed from a roughened surface of a peripheral edge seal in accordance with some embodiments.

FIG. 15 is a cross-sectional view of an illustrative air flow channel having a gasket for restricting air flow in accordance with some embodiments.

FIG. 16 is a flow chart of illustrative operations involved in operating a display of the type shown in FIGS. 1-15 in accordance with some embodiments.

### DETAILED DESCRIPTION

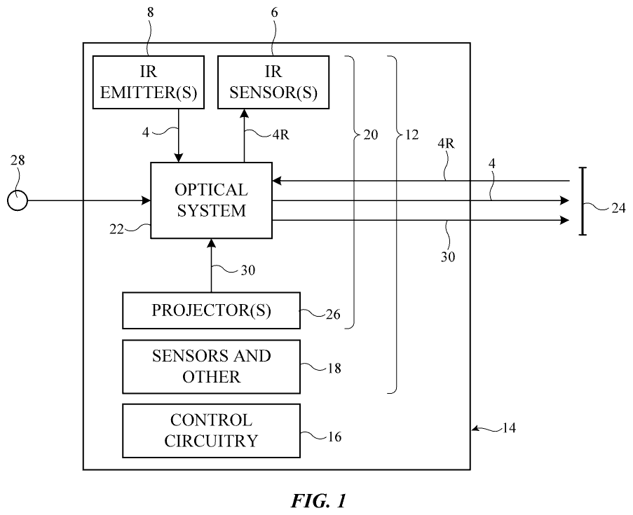

System 10 of FIG. 1 may be an electronic device such as a head-mounted device having one or more displays. The displays in system 10 may include near-eye displays 20 mounted within support structure such as housing 14. Housing 14 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display projectors such as projectors 26 (sometimes referred to herein as display modules 26) and one or more optical systems such as optical systems 22. Projectors 26 may be mounted in a support structure such as housing 14. Each projector 26 may emit image light 30 that is redirected towards a user's eyes at eye box 24 using an associated one of optical systems 22. Image light 30 may be, for example, visible light (e.g., including wavelengths from 400-700 nm) that contains and/or represents something viewable such as a scene or object (e.g., as modulated onto the image light using the image data provided by the control circuitry to the display module).

The operation of system 10 may be controlled using control circuitry 16. Control circuitry 16 may include storage and processing circuitry for controlling the operation of system 10. Control circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may include one or more processors (e.g., microprocessors, microcontrollers, digital signal processors, baseband processors, etc.), power management units, audio chips, graphics processing units, application specific integrated circuits, and other integrated circuits. Software code may be stored on storage in control circuitry 16 and run on processing circuitry in control circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Projectors 26 may include liquid crystal displays, organic light-emitting diode displays, laser-based displays, or displays of other types. Projectors 26 may include light sources, emissive display panels, transmissive display panels that are illuminated with illumination light from light sources to produce image light, reflective display panels such as digital micromirror display (DMD) panels and/or liquid crystal on silicon (LCOS) display panels that are illuminated with illumination light from light sources to produce image light 30, etc.

Optical systems 22 may form lenses that allow a viewer (see, e.g., a viewer's eyes at eye box 24) to view images on display(s) 20. There may be two optical systems 22 (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 22 may be selected so that any gap present between the displays will not be visible to a user (e.g., so that the images of the left and right displays overlap or merge seamlessly).

If desired, optical system 22 may contain components (e.g., an optical combiner formed from reflective components, diffractive components, a waveguide, a direct view optical combiner, etc.) to allow real-world light (sometimes referred to as world light) from real-world (external) objects such as real-world (external) object 28 to be combined optically with virtual (computer-generated) images such as virtual images in image light 30. In this type of system, which is sometimes referred to as an augmented reality system, a user of system 10 may view both real-world content (e.g., world light from object 28) and computer-generated content that is overlaid on top of the real-world content. Camera-based augmented reality systems may also be used in device 10 (e.g., in an arrangement in which a camera captures real-world images of object 28 and this content is digitally merged with virtual content at optical system 22).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

If desired, system 10 may include an optical sensor. The optical sensor may be used to gather optical sensor data associated with a user's eyes at eye box 24. The optical sensor may, for example, be a gaze tracking sensor that gathers optical sensor data such as gaze image data (gaze tracking image data or gaze tracking sensor data) from a user's eye at eye box 24. Control circuitry 16 may process the optical sensor data to identify and track the direction of the user's gaze in real time. Control circuitry 16 may perform any desired operations based on the tracked direction of the user's gaze over time.

As shown in FIG. 1, the optical sensor (gaze tracking sensor) may include one or more optical emitters such as infrared emitter(s) 8 and one or more optical receivers (sensors) such as infrared sensor(s) 6 (sometimes referred to herein as optical sensor 6). Infrared emitter(s) 8 may include one or more light sources that emit sensing light such as light 4. Light 4 may be used for performing optical sensing on/at eye box 24 (e.g., gaze tracking) rather than conveying pixels of image data such as in image light 30. Light 4 may include infrared light. The infrared light may be at infrared (IR) wavelengths and/or near-infrared (NIR) wavelengths (e.g., any desired wavelengths from around 700 nm to around 15 microns). Light 4 may additionally or alternatively include wavelengths less than 700 nm if desired. Light 4 may sometimes be referred to herein as sensor light 4.

Infrared emitter(s) 8 may direct light 4 towards optical system 22. Optical system 22 may direct the light 4 emitted by infrared emitter(s) 8 towards eye box 24. Light 4 may reflect off portions (regions) of the user's eye at eye box 24 as reflected light 4R (sometimes referred to herein as reflected sensor light 4R, which is a reflected version of light 4). Optical system 22 may receive reflected light 4R and may direct reflected light 4R towards infrared sensor(s) 6. Infrared sensor(s) 6 may receive reflected light 4R from optical system 22 and may gather (e.g., generate, measure, sense, produce, etc.) optical sensor data in response to the received reflected light 4R. Infrared sensor(s) 6 may include an image sensor or camera (e.g., an infrared image sensor or camera), for example. Infrared sensor(s) 6 may include, for example, one or more image sensor pixels (e.g., arrays of image sensor pixels). The optical sensor data may include image sensor data (e.g., image data, infrared image data, one or more images, etc.). Infrared sensor(s) 6 may pass the optical sensor data to control circuitry 16 for further processing. Infrared sensor(s) 6 and infrared emitter(s) 8 may be omitted if desired.

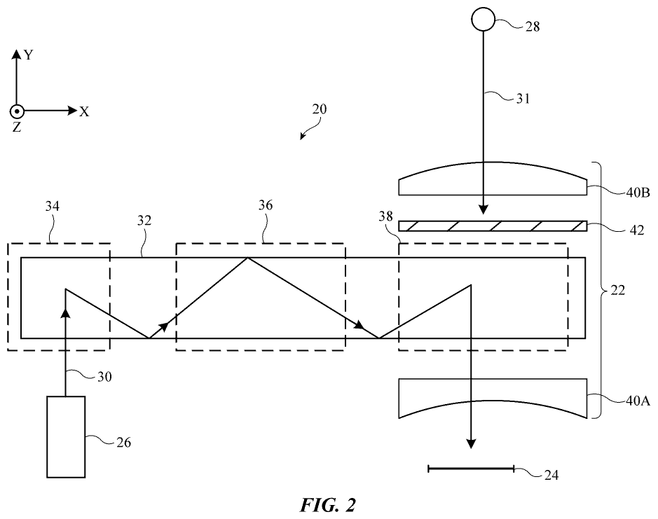

FIG. 2 is a top view of an illustrative display 20 that may be used in system 10 of FIG. 1. As shown in FIG. 2, display 20 may include a projector such as projector 26 and an optical system such as optical system 22. Optical system 22 may include optical elements such as one or more waveguides 32. Waveguide 32 may include one or more stacked substrates (e.g., stacked planar and/or curved layers sometimes referred to herein as waveguide substrates) of optically transparent material such as plastic, polymer, glass, etc.

If desired, waveguide 32 may also include one or more layers of holographic recording media (sometimes referred to herein as holographic media, grating media, or diffraction grating media) on which one or more diffractive gratings are recorded (e.g., holographic phase gratings, sometimes referred to herein as holograms, surface relief gratings, etc.). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating medium may include photopolymers, gelatin such as dichromated gelatin, silver halides, holographic polymer dispersed liquid crystal, or other suitable holographic media.

Diffractive gratings on waveguide 32 may include holographic phase gratings such as volume holograms or thin-film holograms, meta-gratings, or any other desired diffractive grating structures. The diffractive gratings on waveguide 32 may also include surface relief gratings (SRGs) formed on one or more surfaces of the substrates in waveguide 32 (e.g., as modulations in thickness of a SRG medium layer). The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles). Other light redirecting elements such as louvered mirrors may be used in place of diffractive gratings in waveguide 32 if desired.

As shown in FIG. 2, projector 26 may generate (e.g., produce and emit) image light 30 associated with image content to be displayed to eye box 24 (e.g., image light 30 may convey a series of image frames for display at eye box 24). Image light 30 may be collimated using a collimating lens in projector 26 if desired. Optical system 22 may be used to present image light 30 output from projector 26 to eye box 24. If desired, projector 26 may be mounted within support structure 14 of FIG. 1 while optical system 22 may be mounted between portions of support structure 14 (e.g., to form a lens that aligns with eye box 24). Other mounting arrangements may be used, if desired.

Optical system 22 may include one or more optical couplers (e.g., light redirecting elements) such as input coupler 34, cross-coupler 36, and output coupler 38. In the example of FIG. 2, input coupler 34, cross-coupler 36, and output coupler 38 are formed at or on waveguide 32. Input coupler 34, cross-coupler 36, and/or output coupler 38 may be completely embedded within the substrate layers of waveguide 32, may be partially embedded within the substrate layers of waveguide 32, may be mounted to waveguide 32 (e.g., mounted to an exterior surface of waveguide 32), etc.

Waveguide 32 may guide image light 30 down its length via total internal reflection. Input coupler 34 may be configured to couple image light 30 from projector 26 into waveguide 32 (e.g., within a total-internal reflection (TIR) range of the waveguide within which light propagates down the waveguide via TIR), whereas output coupler 38 may be configured to couple image light 30 from within waveguide 32 (e.g., propagating within the TIR range) to the exterior of waveguide 32 and towards eye box 24 (e.g., at angles outside of the TIR range). Input coupler 34 may include an input coupling prism, an edge or face of waveguide 32, a lens, a steering mirror or liquid crystal steering element, diffractive grating structures (e.g., volume holograms, SRGs, etc.), partially reflective structures (e.g., louvered mirrors), or any other desired input coupling elements.

As an example, projector 26 may emit image light 30 in direction +Y towards optical system 22. When image light 30 strikes input coupler 34, input coupler 34 may redirect image light 30 so that the light propagates within waveguide 32 via total internal reflection towards output coupler 38 (e.g., in direction +X within the TIR range of waveguide 32). When image light 30 strikes output coupler 38, output coupler 38 may redirect image light 30 out of waveguide 32 towards eye box 24 (e.g., back along the Y-axis). In implementations where cross-coupler 36 is formed on waveguide 32, cross-coupler 36 may redirect image light 30 in one or more directions as it propagates down the length of waveguide 32 (e.g., towards output coupler 38 from a direction of propagation as coupled into the waveguide by the input coupler). In redirecting image light 30, cross-coupler 36 may also perform pupil expansion on image light 30 in one or more directions. In expanding pupils of the image light, cross-coupler 36 may, for example, help to reduce the vertical size of waveguide 32 (e.g., in the Z direction) relative to implementations where cross-coupler 36 is omitted. Cross-coupler 36 may therefore sometimes also be referred to herein as pupil expander 36 or optical expander 36. If desired, output coupler 38 may also expand image light 30 upon coupling the image light out of waveguide 32.

Input coupler 34, cross-coupler 36, and/or output coupler 38 may be based on reflective and refractive optics or may be based on diffractive (e.g., holographic) optics. In arrangements where couplers 34, 36, and 38 are formed from reflective and refractive optics, couplers 34, 36, and 38 may include one or more reflectors (e.g., an array of micromirrors, partial mirrors, louvered mirrors, or other reflectors). In arrangements where couplers 34, 36, and 38 are based on diffractive optics, couplers 34, 36, and 38 may include diffractive gratings (e.g., volume holograms, surface relief gratings, etc.).

The example of FIG. 2 is illustrative and non-limiting. Optical system 22 may include multiple waveguides that are laterally and/or vertically stacked with respect to each other. Each waveguide may include one, two, all, or none of couplers 34, 36, and 38. Waveguide 32 may be at least partially curved or bent if desired. One or more of couplers 34, 36, and 38 may be omitted. If desired, optical system 22 may include a single optical coupler that performs the operations of both cross-coupler 36 and output coupler 38 (sometimes referred to herein as an interleaved coupler, a diamond coupler, or a diamond expander) or cross-coupler 36 may be separate from output coupler 38.

The operation of optical system 22 on image light 30 is shown in FIG. 2. Optical system 22 may also direct light 4 from infrared emitter(s) 8 towards eye box 24 and may direct reflected light 4R from eye box 24 towards infrared sensor(s) 6 (FIG. 1). In addition, output coupler 38 may form an optical combiner for image light 30 and world light 31 from real-world objects such as real-world object 28. As shown in FIG. 2, world light 31 (sometimes referred to herein as ambient light 31, environmental light 31, external light 31, real-world light 31, or scene light 31) from real-world object 28 may pass through output coupler 38, which transmits the world light (e.g., without diffracting the world light) to eye box 24.

Projector 26 may receive image data that includes the virtual object images (e.g., pixels of image data at different pixel locations that form the virtual object images). Projector 26 may generate image light 30 to include the virtual object images, sometimes referred to herein as images of virtual objects or simply as virtual objects. Output coupler 38 may overlay the virtual object images with world light 31 from real-world object 28 within the field of view (FOV) of eye box 24. The control circuitry for system 10 may provide image data to projector 26 that places the virtual object images at desired locations within the FOV at eye box 24 (e.g., such that the virtual object images are overlaid with desired real-world objects in the scene/environment in front of system 10.)

Optical system 22 may include optics that operate on (e.g., transmit) world light 31 in passing the world light to output coupler 38. The optics may include one or more lenses 40 and/or a light-absorbing layer such as tint layer 42. Lenses 40 and tint layer 42 may overlap output coupler 38 (e.g., when viewed in the −Y direction). For example, optical system 22 may include at least a first lens 40A and a second lens 40B. Lens 40B may be interposed between waveguide 32 and real-world object 28. Lens 40A may be interposed between waveguide 32 and eye box 24. Lenses 40 are transparent and allow world light 31 from real-world object 28 to pass to eye box 24 for view by the user. At the same time, the user can view virtual object images directed out of waveguide 32 and through lens 40A to eye box 24. Lenses 40A and 40B may sometimes also be referred to herein as lens elements.

The strength (sometimes referred to as the optical power, power, or diopter) of lens 40A can be selected to place virtual object images in image light 30 at a desired image distance (depth) from eye box 24 (sometimes referred to herein as a virtual object distance, virtual object image distance, virtual image distance (VID), virtual object depth, virtual image depth, or image depth). For example, it may be desirable to place virtual objects (virtual object images) such as text, icons, moving images, characters, effects, or other content or features at a certain virtual image distance (e.g., to integrate the virtual object image within, onto, into, or around the real-world objects in front of system 10). The placement of the virtual object at that distance can be accomplished by appropriate selection of the strength of lens 40A. Lens 40A may be a negative lens for users whose eyes do not have refraction errors. The strength (larger net negative power) of lens 40A can therefore be selected to adjust the distance (depth) of the virtual object. Lens 40A may therefore sometimes be referred to herein as bias lens 40A or bias− (B−) lens 40A.

If desired, lens 40B may have a complementary power value (e.g., a positive power with a magnitude that matches the magnitude of the negative power of lens 40A). Lens 40B may therefore sometimes be referred to herein as bias+ (B+) lens 40B, complementary lens 40B, or compensation lens 40B. For example, if lens 40A has a power of −2.0 diopter, lens 40B may have an equal and opposite power of +2.0 diopter (as an example). In this type of arrangement, the positive power of lens 40B cancels the negative power of lens 40A. As a result, the overall power of lenses 40A and 40B taken together will be 0 diopter. This allows a viewer to view real-world objects such as real-world object 28 without optical influence from lenses 40A and 40B. For example, a real-world object 28 located far away from system 10 (effectively at infinity), may be viewed as if lenses 40A and 40B were not present.

For a user with satisfactory uncorrected vision, this type of complementary lens arrangement therefore allows virtual objects to be placed in close proximity to the user (e.g., at a virtual image distance of 0.5-5 m, at least 0.1 m, at least 1 m, at least 2 m, less than 20 m, less than 10 m, less than 5 m, or other suitable near-to-midrange distance from device 10 while simultaneously allowing the user to view real world objects without modification by the optical components of the optical system). For example, a real-world object located at a distance of 2 m from device 10 (e.g., a real-world object being labeled by a virtual text label at a virtual image distance of 2 m) will optically appear to be located 2 m from device 10. This is merely illustrative and, if desired, lenses 40A and 40B need not be complementary lenses (e.g., lenses 40A and 40B may have any desired optical powers).

In addition, some users may require vision correction. Vision correction may be provided using tunable lenses, fixed (e.g., removable) lenses (sometimes referred to as supplemental lenses, vision correction lenses, removable lenses, or clip-on lenses), and/or by adjusting the optical power of lens 40A and/or lens 40B to implement the desired vision correction. In general, the vision correction imparted to the lens(es) may include corrections for ametropia (eyes with refractive errors) such as lenses to correct for nearsightedness (myopia), corrections for farsightedness (hyperopia), corrections for astigmatism, corrections for skewed vision, corrections to help accommodate age-related reductions in the range of accommodation exhibited by the eyes (sometimes referred to as presbyopia), and/or other vision disorders.

Lenses 40A and 40B may be provided with any desired optical powers and any desired shapes (e.g., may be plano-convex lenses, plano-concave lenses, plano-freeform lenses, freeform-convex lenses, freeform-concave lenses, convex-concave lenses, freeform-freeform lenses, etc.). Implementations in which the optical power(s) of lenses 40A and/or 40B are fixed (e.g., upon manufacture) are described herein as an example. If desired, one or both of lenses 40A and/or 40B may be electrically adjustable to impart different optical powers or power profiles over time (e.g., lenses 40A and/or 40B may be adjustable/tunable liquid crystal lenses).

In some operating conditions, such as when system 10 is operated outdoors, in rooms with bright lighting, or in other environments having relatively high light levels, world light from real-world objects 28 can overpower or wash out virtual objects presented to eye box 24 in image light 30, thereby limiting the contrast and visibility of the virtual objects when viewed at eye box 24. To reduce the brightness of the world light and maximize the contrast of the images (virtual objects) in image light 30 when viewed at eye box 24, optical system 22 may include a light-absorbing layer such as tint layer 42. Tint layer 42 may be disposed within the optical path between real-world objects 28 and output coupler 38 (e.g., lens 40B and/or tint layer 42 may transmit world light 31 to output coupler 38). World light 31 from real-world objects 28 may pass through tint layer 42 prior to reaching eye box 24 (e.g., tint layer 42 may transmit world light 31 without transmitting image light 30). Tint layer 42 may absorb some of world light 31, thereby reducing its brightness and increasing the contrast of virtual objects in image light 30 at eye box 24. If desired, the tint layer may also function to absorb world light 31, even when the virtual image is turned off, performing a function like switchable sunglasses.

Tint layer 42 may be a fixed tint layer or may be a dynamically adjustable tint layer. When implemented as a fixed tint layer, tint layer 42 has a fixed transmission profile that absorbs the same amount of incident world light over time. Fixed tint layers may be formed from a polymer film containing dye and/or pigment (as an example). When implemented as a dynamically (electrically) adjustable tint layer, tint layer 42 has a dynamically (electrically) adjustable transmission profile. In these implementations, tint layer 42 may be controlled by control signals from control circuitry 16. Implementations in which tint layer 42 is a dynamically adjustable tint layer are described herein as an example. However, in general, tint layer 42 as described herein may be replaced with a fixed tint layer.

Electrically adjustable tint layers (sometimes referred to as electrically adjustable light modulators or electrically adjustable light modulator layers) may be formed from an organic or inorganic electrochromic light modulator layer or a guest-host liquid crystal light modulator layer. When implemented using organic electrochromic tint materials, the active tint materials in the tint layer may be formed from one or more polymer layers which change their absorption upon being oxidized or reduced by charge from adjacent electrodes, or the active tint materials in the tint layer may be made from one or more species of organic small molecules, which diffuse in a liquid or gel medium and change their absorption upon being oxidized or reduced by charge from adjacent electrodes. When implemented using inorganic electrochromic tint materials, the active tint materials may be formed from one or more metal oxides, which change their absorption upon being oxidized or reduced by charge from adjacent electrodes, and may include counter-ions. Implementations in which tint layer 42 includes electrochromic tint material such as a layer of cured electrochromic gel are described herein as an example.

During operation of system 10, the electrically adjustable tint layer may be dynamically placed in a high transmission mode (sometimes referred to herein as a clear state) when it is desired to enhance the visibility of real-world objects or in a lower transmission mode (sometimes referred to herein as a dark state) when it is desired to reduce scene brightness and thereby help enhance the viewability of image light from projector 26 (e.g., to allow virtual objects such as virtual objects in image light 30 to be viewed without being overwhelmed by bright environmental light). If desired, tint layer 42 may also be controlled to exhibit intermediate levels of transmission and/or transmission levels that vary across the field of view of eye box 24.

Tint layer 42 may be planar (e.g., having a lateral surface that lies in a flat plane) or may be curved (e.g., having a lateral surface that is curved and non-planar). Tint layer 42 may be disposed at any desired location within optical system 22 between real-world objects 28 (e.g., the scene in front of system 10) and output coupler 38 on waveguide 32. Device 10 may include multiple overlapping tint layers if desired.

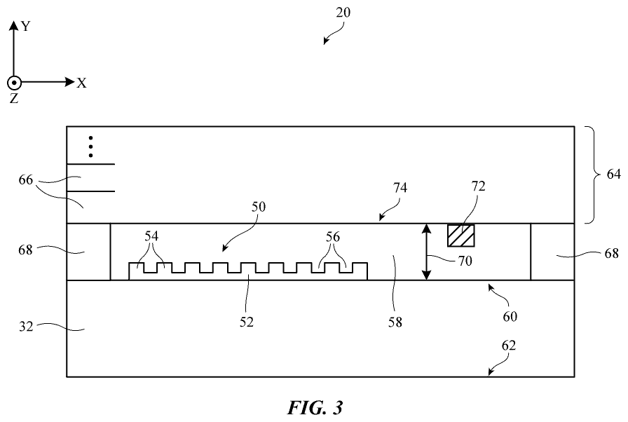

Display 20 may include optics that are mounted to waveguide 32 and that are separated from waveguide 32 by an air cavity. FIG. 3 is a cross-sectional top view showing one example of how display 20 may include optics that are mounted to waveguide 32 and that are separated from waveguide 32 by an air cavity.

As shown in FIG. 3, waveguide 32 may have one or more (e.g., stacked) waveguide substrates that define a first lateral surface 60 of waveguide 32 and an opposing second lateral surface 62 of waveguide 32. Lateral surface 60 may extend parallel to lateral surface 62. Lateral surfaces 60 and 62 may be planar or may be curved. Lateral surfaces 60 and 62 are sometimes also referred to herein as waveguide surfaces.

Display 20 may include optics 64 that are mounted to lateral surface 60 of waveguide 32 (e.g., the side of waveguide 32 facing away from the eye box). Optics 64 may include one or more optical layers 66 that are stacked on top of each other. Optics 64 may have a lateral surface 74 (e.g., the lateral surface of the lowermost layer 66) that faces waveguide 32 and that is separated from lateral surface 60 of waveguide 32 by air cavity 58. Optics 64 may be mounted to waveguide 32 using any suitable mounting structures. For example, as shown in FIG. 3, display 20 may include a spacer such as peripheral edge seal 68 that mounts or couples lateral surface 74 of optics 64 to lateral surface 60 of waveguide 32.

Peripheral edge seal 68 may be formed from a ring of epoxy, adhesive, or another material and may adhere, affix, or secure optics 64 to waveguide 32. Peripheral edge seal 68 may extend around the lateral periphery of air cavity 58 (e.g., in the X-Z plane) and may laterally surround and enclose air cavity 58 between optics 64 and waveguide 32 (e.g., the edges or walls of air cavity 58 may be defined by lateral surface 74, lateral surface 60, and peripheral edge seal 68).

Optics 64 may include any desired optical components mounted to waveguide 32. Optics 64 may transmit world light 31 (FIG. 2) to waveguide 32. Optics 64 may include some or all of tint layer 42 of FIG. 2 and/or some or all of lens 40B of FIG. 2, for example. Layers 66 may include one or more glass layers, plastic layers (e.g., transparent cover layers), electrochromic layers (e.g., layers of electrochromic gel), liquid crystal layers, prism layers, polarizer layers, partially reflective layers, dielectric layers, metallic layers, electrode layers, some or all of one or more additional waveguides, protective cover layers, layers of optically clear adhesive, epoxy layers, adhesive layers, antireflective layers, oleophobic layers, heating layers, lenses, lens elements, and/or any other desired optical layers, as examples.

Display 20 may include one or more optical components mounted within air cavity 58. For example, display 20 may include a grating structure layered onto lateral surface 60 such as surface relief grating (SRG) 50. SRG 50 may be formed from modulations in the thickness of an associated SRG substrate layered onto lateral surface 60. SRG 50 may include peaks 54 and troughs 56 in the thickness of the SRG substrate. Peaks 54 are sometimes also referred to herein as ridges 54 or maxima 54. Troughs 56 are sometimes also referred to herein as notches 56, slots 56, grooves 56, or minima 56.

In the example of FIG. 3, SRG 50 is illustrated for the sake of clarity as a binary structure in which SRG 50 is defined either by a first thickness associated with ridges 54 or a second thickness associated with troughs 56. This is merely illustrative. If desired, SRG 50 may be non-binary (e.g., may include any desired number of thicknesses following any desired profile, may include ridges 54 that are angled at non-parallel fringe angles with respect to the Y axis, etc.), may include ridges 54 with surfaces that are tilted (e.g., oriented outside of the X-Z plane), may include troughs 56 that are tilted (e.g., oriented outside of the X-Z plane), may include ridges 54 and/or troughs 56 that have heights and/or depths that follow a modulation envelope, etc. If desired, the SRG substrate may be adhered to lateral surface 60 of waveguide 32 using a layer of optically clear adhesive (not shown). SRG 50 may be fabricated separately from waveguide 32 and may be adhered to waveguide 32 after fabrication or may be etched into the SRG substrate 76 after the SRG substrate has already been layered on waveguide 32, for example.

SRG 50 may form an optical coupler for waveguide 32. SRG 50 may, for example, form input coupler 34, cross coupler 36, and/or output coupler 38 of waveguide 32 (FIG. 2). An implementation in which SRG 50 forms output coupler 38 is sometimes described herein as an example. In this example, SRG 50 redirects (diffracts), out of waveguide 32 and towards the eye box, image light 30 propagating along waveguide 32 via total internal reflection (see, e.g., FIG. 2). If desired, one or more infrared components 72 may also be mounted within air cavity 58 (e.g., to lateral surface 74 or lateral surface 60). Infrared components 72 may include IR emitter(s) 8 and/or IR sensor(s) 6 of FIG. 1, for example.

In a steady/equilibrium state, air cavity 58 may have a thickness 70 (e.g., lateral surface 74 may be separated from lateral surface 60 by the thickness 70 of air cavity 58). Air cavity 58 is filled with air and is sometimes also be referred to herein as air gap 58 or more simply as cavity 58. In practice, it is desirable for display 20 and thus thickness 70 to be as thin as possible. However, when display 20 is subject to an external force such as a drop or impact event, optics 64 and/or waveguide 32 can be momentarily deformed or bent towards each other by the external force, closing the thickness 70 of air cavity 58 and subjecting sensitive components within air cavity 58 to damage.

These deformations can be mitigated by increasing the thickness of optics 64 and/or waveguide 32 but, in general, it is desirable for display 20 to be as thin and lightweight as possible (e.g., to maximize comfort while the user wears display 20 on their head). These deformations can also be mitigated by disposing optically clear sacrificial bumpers within air cavity 58 to help maintain thickness 70 during a drop or impact event. However, optically clear sacrificial bumpers undesirably increase the weight of display 20 and can produce unsightly visual artifacts in the world light and/or image light provided to the eye box. At the same time, air within air cavity 58 needs to be able to move between air cavity 58 and the surrounding environment to avoid display bulging and/or image warping during manufacture, shipping, and use of device 10, particularly as the air pressure of the environment around display 20 changes over time. Further, care should be taken so as to minimize the ingress of moisture, dust, or other contaminants into air cavity 58, as the contaminants can damage or deteriorate the performance of SRG 50 and/or infrared components 72.

To mitigate potential damage from external forces without impacting image quality or increasing the thickness/weight of display 20 and while still allowing air to flow between air cavity and the surrounding environment and while still protecting air cavity 58 from contaminants, display 20 may be provided with one or more air flow channels 84 between air cavity 58 and the surrounding environment. The air flow channel(s) may configure air cavity 58 to form a quasi-constrained air cavity rather than a completely enclosed (constrained) air cavity or an open air cavity. The air flow channel(s) may be formed in peripheral edge seal 68 and/or one or more layers 66 of optics 64, for example.

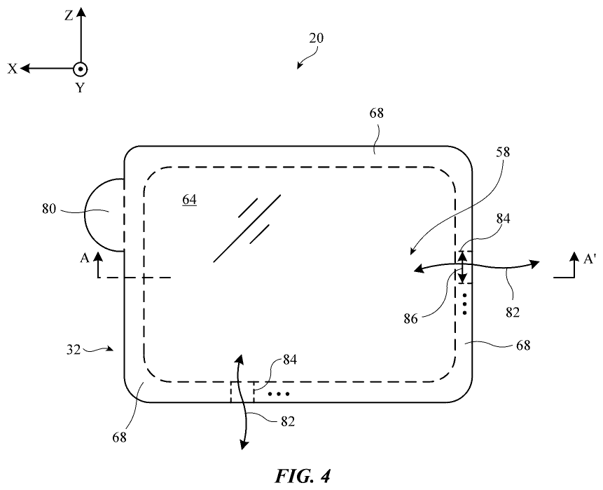

FIG. 4 is a front view showing how display 20 may include air flow channels 84 between air cavity 58 and the surrounding environment. As shown in FIG. 4, optics 64 may be layered over waveguide 32 and may be coupled to waveguide 32 by peripheral edge seal 68. Air cavity 58 may be interposed between optics 64 and waveguide 32. Peripheral edge seal 68 may extend around the lateral periphery of air cavity 58, enclosing air between peripheral edge seal 68, optics 64, and waveguide 32 (e.g., within air cavity 58).

If desired, waveguide 32 and/or optics 64 may include an extension 80 that extends or protrudes away from peripheral edge seal 68. Image light may be coupled into waveguide 32 through extension 80 (e.g., from projector 26 of FIG. 2) and/or electrical components in optics 64 (e.g., an adjustable tint layer 42 as shown in FIG. 2) may be driven by electrical signals provided through extension 80.

As shown in FIG. 4, one or more air flow channels 84 may be provided at one or more locations around the lateral periphery of air cavity 58. Air flow channels 84 are sometimes also referred to herein as air channels 84 or simply as channels 84. Air flow channels 84 may be formed or disposed within peripheral edge seal 68 and/or optics 64. Each air flow channel 84 may have a corresponding width 86. Different air flow channels 84 may have the same width 86 or may have different widths 86.

Each air flow channel 84 may allow air to flow out of air cavity 58 and into the surrounding environment and may allow air to flow from the surrounding environment into air cavity 58, as shown by arrows 82. If desired, width 86 may be sufficiently small so as to block moisture, dust, or other contaminants from passing into air cavity 58 through air flow channels 84 (e.g., less than 100 microns). In general, narrower widths 86 allow for less air flow than wider widths 86 over a given time period. When display 20 is subjected to an external force that tends to compress air cavity 58, the compression pushes air out of air cavity 58 through air flow channels 84. By selecting width 86 to be relatively narrow, air flow channel(s) 84 may help to restrict the flow (egress) of air out of air cavity 58 when air cavity 58 is subjected to external forces. This restriction helps to temporarily trap or constrain the air within air cavity 58, allowing air cavity 58 to maintain its volume (e.g., thickness 70 of FIG. 3) and thus preventing damage to the components within air cavity 58 (e.g., SRG 50 and infrared components 72). In this way, the air flow channel(s) may configure air cavity 58 to form an air cushion or pillow for the components within air cavity 58 when subject to an external force over a relatively short time period.

In general, the number of air flow channels 84, the locations of air flow channels 84, and the geometries of air flow channels 84 (e.g., widths 86) define the speed with which air flows between air cavity 58 and the surrounding environment both on short and long time scales. As such, the number of air flow channels 84, the locations of air flow channels 84, and the geometries of air flow channels 84 (e.g., widths 86) may be selected to configure peripheral edge seal 68, optics 64, and waveguide 32 to trap or confine the air within air cavity 58 when display 20 is subject to a momentary or temporary external force on a relatively short time scale (e.g., an impact or drop event, which occurs on a time scale less than 1 second such as on the order of a few, tens, or hundreds of microseconds or milliseconds) while also allowing air to freely pass between air cavity 58 and the surrounding environment on a relatively long time scale (e.g., a time scale greater than 1 second such as 1-10 seconds). The combined widths 86 of all of the air flow channels 84 in display 20 may, for example, collectively extend across a relatively small amount of the lateral perimeter of air cavity 58 (e.g., less than 10% of the lateral perimeter of air cavity 58, less than 5% of the lateral perimeter of air cavity 58, less than 2% of the lateral perimeter of air cavity 58, less than 1% of the lateral perimeter of air cavity 58, less than 0.5% of the lateral perimeter of air cavity 58, less than 0.1% of the lateral perimeter of air cavity 58, etc.).

By trapping or confining air within air cavity 58 on the short time scale of an impact event, air cavity 58 is able to maintain a relatively uniform volume and thickness 70 during the impact event, preventing optics 64 and/or waveguide 32 from deforming or bending onto each other and damaging SRG 50 and/or infrared components 72. On the other hand, by allowing air to pass between air cavity 58 and the surrounding environment on longer time scales, air flow channel(s) 84 also allow the air pressure within air cavity 58 to gradually equalize with the air pressure of the surrounding environment (e.g., as device 10 moves between areas of different air pressures such as between different altitudes over time). This serves to prevent warping, buckling, bulging, or other damage associated with pressure differentials between air cavity 58 and the surrounding environment over the operating life of device 10. When configured in this way, air cavity 58 is sometimes referred to as a quasi-constrained air cavity.

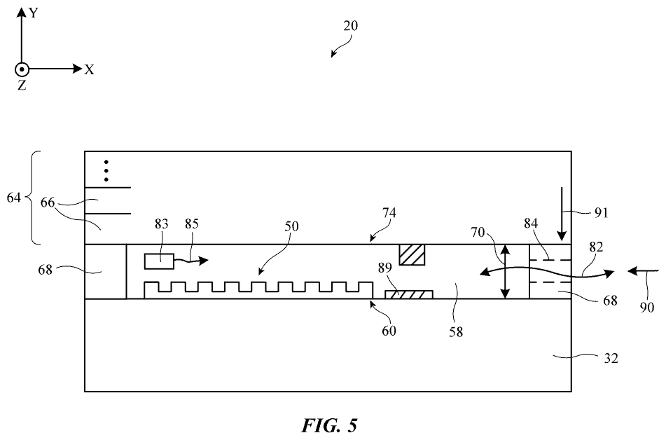

A given air flow channel 84 may be formed within peripheral edge seal 68 and/or optics 64. FIG. 5 is a cross-sectional top view showing one example of how peripheral edge seal 68 may include an air flow channel 84 (e.g., as taken along line AA′ of FIG. 4).

As shown in FIG. 5, an air flow channel 84 may be formed in peripheral edge seal 68. The air flow channel may extend from air cavity 58 to the surrounding environment. Air flow channel 84 may allow air to pass between air cavity 58 and the surrounding environment over relatively long time scales, as shown by arrow 82, while being sufficiently narrow so as to constrain or trap air within air cavity 58 over relatively short time scales such as the time scale of an impact or drop event. Air flow channel 84 may extend from lateral surface 60 to lateral surface 74 (e.g., may be formed from a cut in peripheral edge seal 68 that extends across the entire thickness 70 of air cavity 58) or may extend across only a portion of the thickness 70 of air cavity 58.

If desired, a layer of desiccant material such as desiccant 89 may be disposed within air cavity 58 (e.g., on lateral surface 60 and/or lateral surface 74). Desiccant 89 may help to prevent the accumulation of moisture from the air flowing into cavity 58 through air flow channel 84. Desiccant 89 may be included in air cavity 58 in any of the implementations of display 20 described herein but is omitted from FIGS. 4 and 6-15 for the sake of clarity.

If desired, a powered air flow system 83 may be disposed on, at, or in air cavity 58. Powered air flow system 83 may momentarily inject air 85 into air cavity 58 (e.g., from another air reservoir or from the surrounding environment) to help maintain thickness 70 and the volume of air cavity 58 when display 20 is subject to an impact or drop event. Powered air flow system 83 may include a fan or an electromechanical (e.g., piezoelectric) actuator, as examples. One or more sensors on device 10 (e.g., a motion sensor, accelerometer, compass, gyroscope, inertial measurement unit, proximity sensor, capacitive sensor, touch sensor, force sensor, strain gauge, light sensor, radio-frequency sensor, etc.) may detect when a drop or impact event has occurred or is about to occur and, in response to the detection, the control circuitry on device 10 may control powered air flow system 83 to inject air 85 into air cavity 58 to help maintain the volume and thickness of air cavity 58 during the drop or impact event. Powered air flow system 83 may coupled to or disposed in air cavity 58 in any of the implementations of display 20 described herein but is omitted from FIGS. 4 and 6-15 for the sake of clarity.

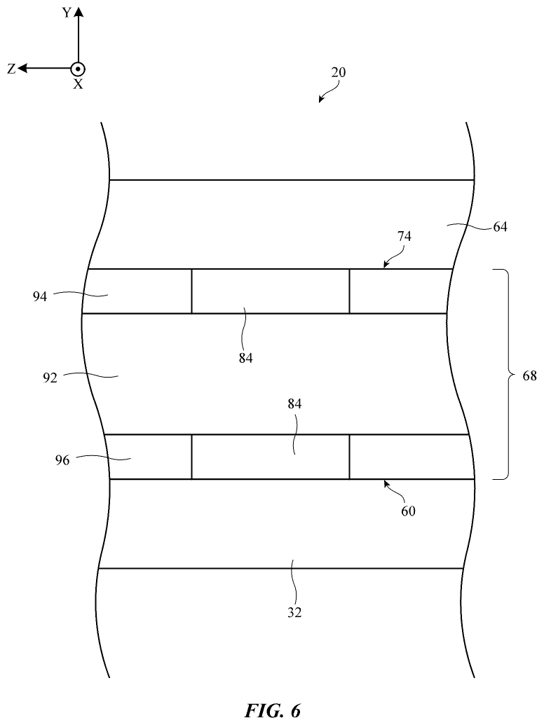

FIGS. 6-10 are cross-sectional side views showing examples of how air flow channel 84 may be formed in peripheral edge seal 68 between optics 64 and waveguide 32 (e.g., as viewed in the direction of arrow 90 of FIG. 5).

As shown in FIG. 6, peripheral edge seal 68 may include multiple layers of material such as a first adhesive layer 94 layered onto lateral surface 74, a second adhesive layer 96 layered onto lateral surface 60, and a third adhesive layer 92 layered (e.g., sandwiched or interposed) between adhesive layers 94 and 96. Adhesive layers 94, 92, and 96 may include any desired materials such as epoxy, polymer, pressure sensitive adhesive (PSA), optically clear adhesive (OCA), etc. As one example, adhesive layer 94 is a first PSA layer, adhesive layer 96 is a second PSA layer, and adhesive layer 92 is a polyethylene terephthalate (PET) layer.

Air flow channel 84 may be formed from a channel, slot, notch, tunnel, or hole in adhesive layer 94 and/or adhesive layer 96. Air flow channel 84 may be formed in only one of adhesive layers 94 and 96 or in both of adhesive layers 94 and 96. When formed in both adhesive layers 94 and 96, the air flow channels 84 in adhesive layers 94 and 96 may overlap each other or may be non-overlapping with respect to each other. If desired, the portion of adhesive layer 92 overlapping the air flow channel(s) 84 in adhesive layer(s) 94 and/or 96 may be free from holes or air flow channels.

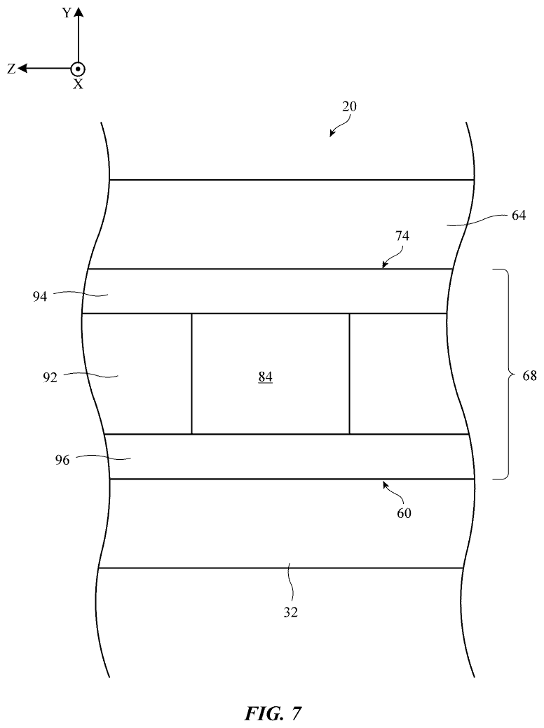

Additionally or alternatively, air flow channel 84 may be formed from a channel, slot, notch, tunnel, or hole in adhesive layer 92, as shown in the example of FIG. 7. If desired, the portions of adhesive layers 94 and 96 overlapping the air flow channel 84 in adhesive layer 92 may be free from holes or air flow channels. Alternatively, air flow channel 84 may be formed from a channel, slot, notch, tunnel, or hole that extends through adhesive layers 94 and 92 (e.g., from lateral surface 74 to adhesive layer 96), through adhesive layers 96 and 92 (e.g., from lateral surface 60 to adhesive layer 94), or through all of adhesive layers 94, 92, and 96 (e.g., from lateral surface 74 to lateral surface 60). The air flow channel(s) 84 in one or more of adhesive layers 94, 92, and 96 may be cut, etched, drilled, or otherwise formed in the adhesive layer(s) after deposition of the adhesive layer(s) or may be formed by selectively dispensing the adhesive layers around the air flow channel(s) (e.g., using a mask).

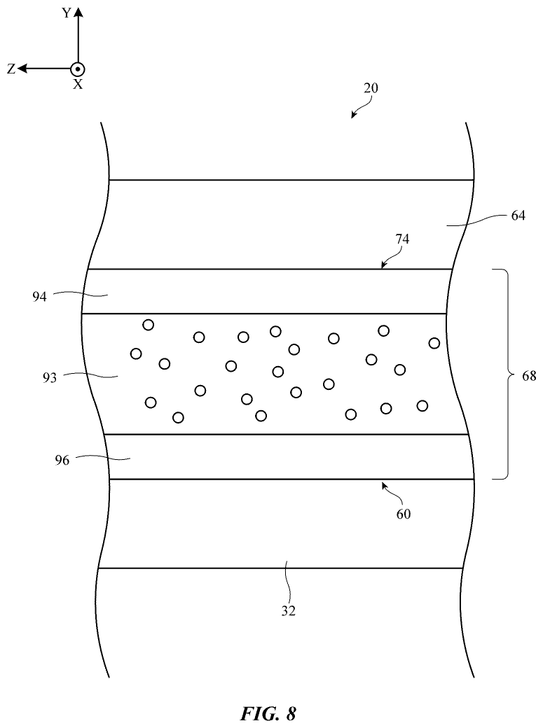

FIG. 8 shows an example in which adhesive layer 92 of FIGS. 6 and 7 is replaced with a layer of open cell foam. As shown in FIG. 8, peripheral edge seal 68 may include a layer of open cell foam 93 (e.g., a rigid or deformable foam gasket) sandwiched between adhesive layers 94 and 96. Open cell foam 93 may include a network/mesh of air cells or pores extending through the lateral thickness of peripheral edge seal 68. The air cells may collectively form many narrow meandering paths for air flow between air cavity 58 and the surrounding environment, which statistically form a corresponding air flow channel 84. If desired, the open cell foam may be confined only to regions around the lateral periphery of air cavity 58 (e.g., regions of peripheral edge seal 68) where air flow channels 84 are formed. Alternatively, open cell foam 93 may extend along the entire lateral periphery of air cavity 58 (peripheral edge seal 68).

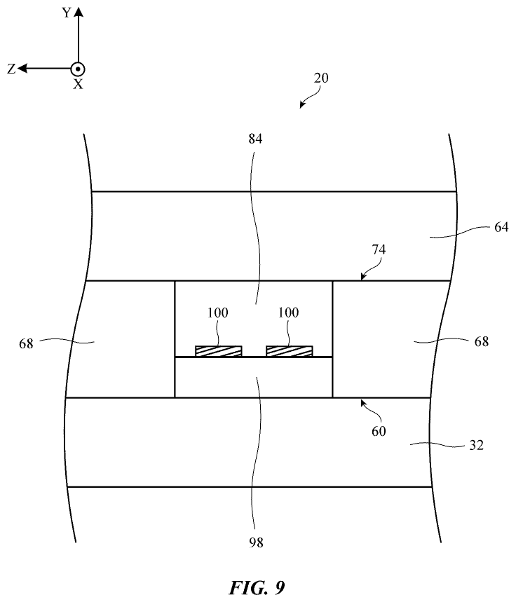

As shown in the example of FIG. 9, a printed circuit 98 (e.g., flexible printed circuit) may be layered onto a lateral surface 60 of waveguide 32 within air flow channel 84 in peripheral edge seal 68. Alternatively, printed circuit 98 may be layered onto lateral surface 74. Printed circuit 98 may extend from outside air cavity 58 into air cavity 58. Printed circuit 84 may extend into air cavity 58 from extension 80 of FIG. 4, for example.

If desired, one or more layers of peripheral edge seal 68 (e.g., adhesive layer 96 of FIGS. 6-8) may be used to adhere printed circuit 98 to lateral surface 60 and/or lateral surface 74. Printed circuit 84 may include conductive traces 100 that convey electrical signals between electrical components within air cavity 58 (e.g., infrared components 72 of FIG. 3) and electrical components outside air cavity 58 (e.g., control circuitry). Conductive traces 100 may, for example, convey control signals that control infrared components 72 to emit infrared light, signals that convey infrared image data gathered by infrared components 72, drive signals for driving electrodes of tint layer 42 (FIG. 2), etc. Alternatively, conductive traces 100 may be patterned directly onto lateral surface 74 and/or lateral surface 60 within air flow channel 84 without printed circuit 98. Alternatively, conductive lead lines or wires for electrical components within air cavity 58 may pass into air cavity 58 through air flow channel 84.

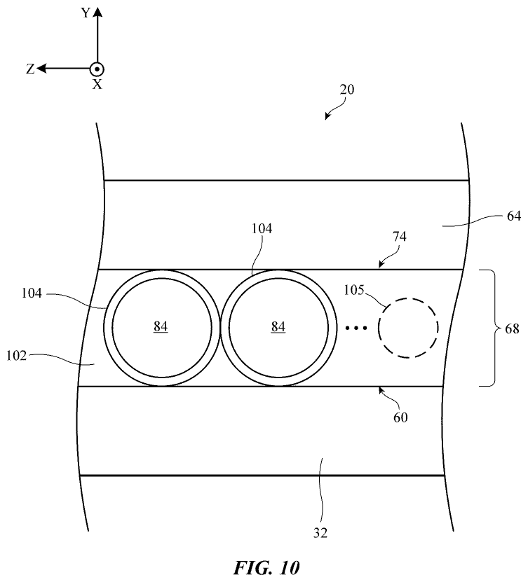

If desired, air flow channels 84 may be formed from hollow tubes extending through peripheral edge seal 68. For example, as shown in FIG. 10, peripheral edge seal 68 may include one or more layers of adhesive 102 (e.g., PSA, PET, etc.). One or more hollow tubes 104 may be disposed or embedded within adhesive 102. Hollow tubes 104 extend from air cavity 58 to the surrounding environment through peripheral edge seal 68. Hollow tubes 104 are filled with air and pass air between air cavity 58 and the surrounding environment. Each hollow tube 104 may form a corresponding air flow channel 84.

Hollow tubes 104 may be formed from plastic or other materials. Hollow tubes 104 may extend from lateral surface 74 to lateral surface 60 (e.g., the diameter of hollow tubes 104 may be equal to the thickness of peripheral edge seal 68) or may extend across only some of the thickness of peripheral edge seal 68 (e.g., the diameter of hollow tubes 104 may be less than the thickness of peripheral edge seal 68 and the hollow tubes may be embedded within adhesive 102 such as at location 105).

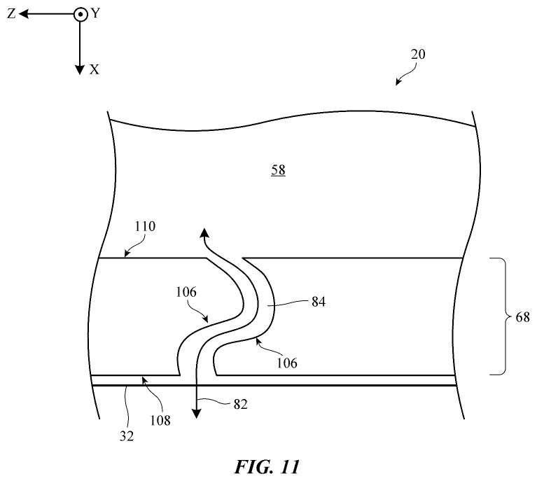

If desired, air flow channel 84 may follow a meandering path from air cavity 58 to the surrounding environment. FIG. 11 is a top view showing how a given air flow channel 84 in peripheral edge seal 68 may follow a meandering path (e.g., as viewed in the direction of arrow 91 of FIG. 5). As shown in FIG. 11, peripheral edge seal 68 may have an interior lateral edge 110 at air cavity 58 and an opposing exterior lateral edge 108 at the surrounding environment. Air flow channel 84 may have lateral edges 106 extending from interior lateral edge 110 to exterior lateral edge 108. Air channel 84 may follow a meandering, non-linear, curved, zig-zag, sinusoidal, and/or tortuous path across the lateral thickness of peripheral edge seal 68 from interior lateral edge 110 to exterior lateral edge 108 (e.g., the lateral edges 106 of air flow channel 84 may be curved, may be non-linear, may follow a meandering path, may follow a tortuous path, etc.). Lateral edges 106 may extend parallel to each other or may be non-parallel if desired. The meandering path may have any desired number of curved and/or straight non-linear segments.

By configuring air flow channel 84 to follow a meandering path in this way, the length of air flow channel 84 (e.g., from interior lateral edge 110 to exterior lateral edge 108) can be increased despite the finite lateral thickness of peripheral edge seal 68. Increasing the length of air flow channel 84 and requiring air to flow out of air flow cavity 58 along a non-linear path serves to increase the amount of time required for the air to flow out of air cavity 58 (relative to a linear air flow channel), effectively helping to trap the air within air cavity 58 on the relatively short time scale of an impact or drop event. At the same time, the meandering path of air flow channel 84 may help to prevent the ingress of dust or other contaminants into air cavity 58.

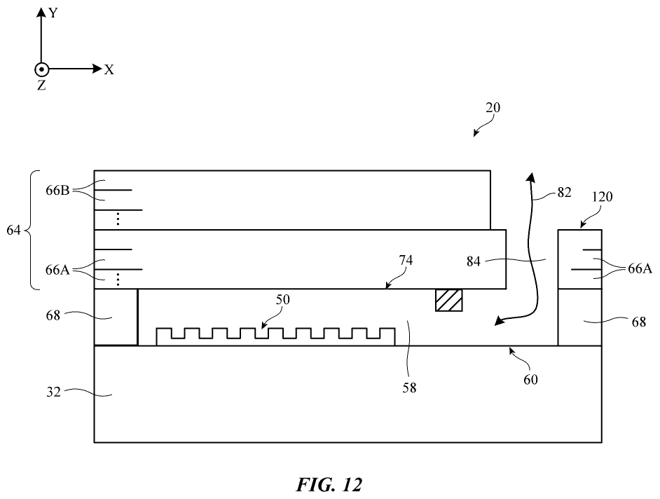

If desired, one or more of the air flow channels 84 in display 20 may be formed within optics 64. FIG. 12 is a cross-sectional top view showing one example of how an air flow channel 84 may be formed in optics 64.

As shown in FIG. 12, air flow channel 84 may be formed from a hole, slot, gap, or opening in optics 64. Air flow channel 84 may extend through all of the layers 66 of optics 64 or through only a subset of the layers of optics 64. For example, air flow channel 84 may extend through layers 66A but not layers 66B of optics 64. In these implementations, layers 66B may extend across some but not all of the lateral area of optics 64 (e.g., without blocking or overlapping air flow channel 84) Layers 66A may include a layer of optically clear adhesive, an electrode layer, a glass or plastic substrate or cover layer, some or all of tint layer 42 (FIG. 2) (e.g., a lower glass substrate layer of the tint layer, where the electrochromic layer and the opposing upper glass substrate layer of the tint layer form layers 66B of optics 64), some or all of lens 40B (FIG. 2), and/or any other desired layers of optics 64.

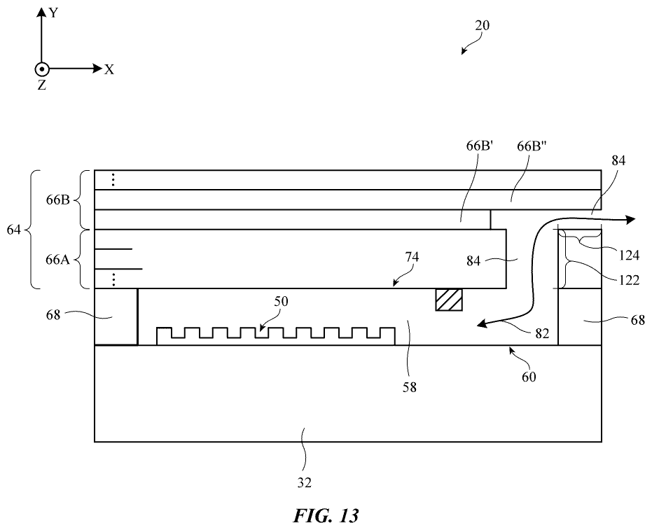

If desired, layers 66B of optics 64 may extend over and may overlap air flow channel 84, as shown in the example of FIG. 13. As shown in FIG. 13, air flow channel 84 may include a first segment 122 extending through layers 66A (e.g., a first set of one or more layers 66 of optics 64) from air cavity 58. Air flow channel 84 may include a second segment 124 extending from the end of segment 122 to the surrounding environment (e.g., segments 122 and 124 may be perpendicular).

Layers 66B may include zero, one, or more than one layer 66B′ that is/are cut or that otherwise do not extend across the entire lateral periphery of optics 64 (e.g., in the X-Z plane). The remaining layers 66B″ of layers 66B extend across the entire lateral periphery of optics 64 and overlap both segments 122 and 124 of air flow channel 84 (e.g., segment 124 of air flow channel 94 is interposed between layers 66B″ and layers 66A). In this way, air flow channel 64 may follow a meandering path from air cavity 58 to the surrounding environment through optics 64. This may, for example, help to slow the rate at which air flows out of air cavity 58 in response to a drop or impact event (e.g., helping to confine air within air cavity 58) and/or may help to prevent the ingress of dust or other contaminants into air cavity 58.

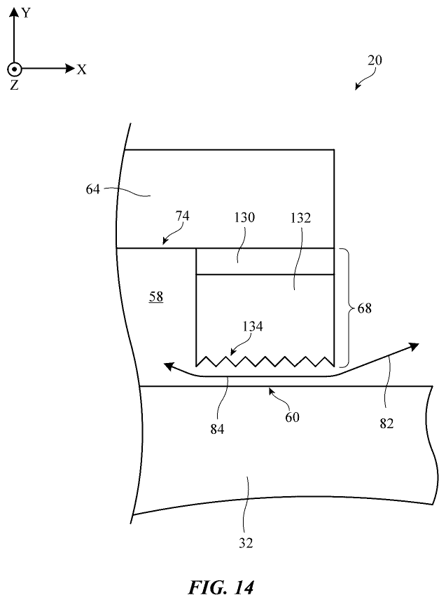

If desired, a given air flow channel 84 may be formed from a textured surface of peripheral edge seal 68, as shown in the cross-sectional top view of FIG. 14. As shown in FIG. 14, peripheral edge seal 68 may include at least a first layer of adhesive 130 (e.g., PSA) and a second layer of adhesive 132 (e.g., PET). Adhesive 130 may be layered onto lateral surface 74 and adhesive 132 may be interposed between adhesive 130 and waveguide 32. Adhesive 132 may have a textured surface such as roughened surface 134 opposite adhesive 130.

Roughened surface 134 may have non-planar features on the micron scale, which serves to limit the amount of contact between adhesive 132 and lateral surface 60 of waveguide 32. This may allow air to flow between air cavity 58 and the surrounding environment between adhesive 132 and lateral surface 60 (as shown by arrow 82), thereby forming a corresponding air flow channel 84. At the same time, roughened surface 134 may help to preserve the TIR condition of waveguide 32 (e.g., by providing an effective refractive index less than that of adhesive 132 at lateral surface 60). Alternatively, adhesive 130 may be layered onto waveguide 32 and roughened surface 134 may face lateral surface 74 of optics 64.

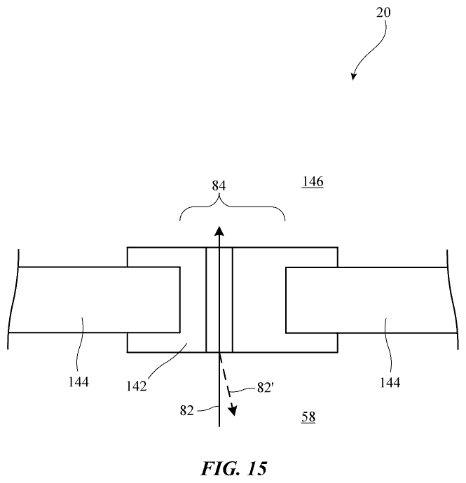

FIG. 15 is a cross-sectional view showing how a given air flow channel 84 (e.g., any air flow channel 84 as described herein and shown in FIGS. 4-14) may be provided with an air flow limiting structure 142. As shown in FIG. 15, air flow channel 84 may be formed within structure 144 and may extend, through structure 144, from air cavity 58 to surrounding environment 146. Structure 144 may be peripheral edge seal 68 and/or one or more layers 66 of optics 64, for example.

Air flow limiting structure 142 (sometimes referred to herein as air flow limiter 142) may be mounted or affixed to structure 144 within and/or overlapping air flow channel 84. Air flow limiting structure 142 may include one or more narrow openings or pores that allow less air flow than when air flow channel 84 does not include air flow limiting structure 142. For example, air flow limiting structure 142 may keep air trapped within air cavity 58 (as shown by arrow 82′) under greater external forces than when air flow channel 84 does not include air flow limiting structure 142. In addition, air flow limiting structure 142 may allow air to flow through air flow channel 84 over relatively long time scales to equalize the pressure within air cavity 58 (as shown by arrow 82).

Air flow limiting structure 142 may be a gasket (e.g., a dust gasket, a silicon gasket, etc.) and/or a membrane having pores or openings that allows some air to flow through the air flow limiting structure, as examples. Implementing air flow limiting structure 142 as a silicon gasket may, for example, allow for a larger hole to be cut in a brittle layer so as to act less like a stress concentration while still limiting air flow, while also preventing dust flow through the air flow channel.

Display 20 may include a single air flow channel 84 or multiple air flow channels 84. In implementations where display 20 includes multiple air flow channels 84, each air flow channel may be the same type of air flow channel or, if desired, different air flow channels 84 around air cavity 58 may be implemented using any desired number or combination of two or more the air flow channels shown in FIGS. 4-15.

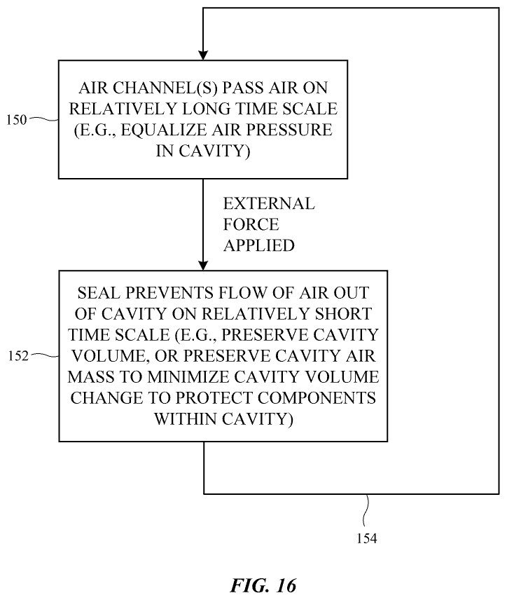

FIG. 16 is a flow chart of operations involved in operating display 20. At operation 150, one or more air flow channels 84 allow air to pass between air cavity 58 and the surrounding environment on a relatively long time scale (e.g., greater than 1 second, 1-10 seconds, etc.). This may serve to equalize the air pressure within air cavity 58 to the air pressure of the surrounding environment. When an external force is applied to display 20, such as in a drop or impact event, processing proceeds to operation 152.

At operation 152, the seal around air cavity 58 (e.g., formed from peripheral edge seal 68, waveguide 32, and optics 64) prevents the rapid flow of air out of air cavity 58 through air flow channel(s) 84 on the relatively short time scale with which the external force is applied to display 20 (e.g., during the drop or impact event, on a millisecond or microsecond time scale). This constraint on air flow out of air cavity 58 causes air cavity 58 to form an air cushion or pillow (e.g., preserving cavity volume or cavity air mass to minimize cavity volume change), thereby protecting the components within air cavity 58 from damage due to compression of the air cavity from the external force. The air flow channel(s) continue to allow air to pass to and from air cavity 58 to continue to equalize the air pressure within air cavity 58 over time (e.g., processing loops back to operation 150 via path 154).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: in contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground. Examples of mixed realities include augmented reality and augmented virtuality. Augmented reality: an augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof. Augmented virtuality: an augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Hardware: there are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, μLEDs, liquid crystal on silicon, laser scanning light sources, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The foregoing is merely illustrative and various modifications can be made to the described embodiments. The foregoing embodiments may be implemented individually or in any combination.

What is claimed is:

1. An electronic device comprising:
a waveguide configured to propagate first light via total internal reflection;
optics mounted to the waveguide and configured to transmit second light to the waveguide;
a ring of adhesive that couples the waveguide to the optics, wherein the ring of adhesive laterally surrounds an air cavity between the optics and the waveguide; and
an air flow channel configured to pass air into and out of the air cavity.

2. The electronic device of claim 1, wherein the air flow channel is configured to confine the air within the air cavity on a first time scale and is configured to pass the air into and out of the air cavity on a second time scale that is longer than the first time scale, wherein the first time scale is less than one second and the second time scale is greater than one second.

3. The electronic device of claim 1, further comprising:
a surface relief grating mounted to the waveguide within the air cavity, the surface relief grating being configured to diffract the first light.

4. The electronic device of claim 1, further comprising:
infrared emitter mounted within the air cavity.

5. The electronic device of claim 1, wherein the optics comprise an electrically adjustable tint layer or a bias lens.

6. The electronic device of claim 1, wherein the air flow channel is disposed in the ring of adhesive.

7. The electronic device of claim 6, wherein the ring of adhesive comprises:
a first layer on the optics;
a second layer on the waveguide; and
a third layer between the first layer and the second layer.

8. The electronic device of claim 7, wherein the air flow channel extends through the first, second, and third layers.

9. The electronic device of claim 7, wherein the second layer comprises open cell foam.

10. The electronic device of claim 7, wherein the first layer and the second layer comprise pressure sensitive adhesive and the third layer comprises polyethylene terephthalate.

11. The electronic device of claim 6, further comprising:
a flexible printed circuit that extends through the air flow channel.

12. The electronic device of claim 6, wherein the air flow channel comprises a hollow tube embedded in the ring of adhesive.

13. The electronic device of claim 6, wherein the air flow channel follows a meandering path from an interior lateral edge of the ring of adhesive to an exterior lateral edge of the ring of adhesive.

14. The electronic device of claim 6, wherein the ring of adhesive comprises a first layer on the optics and a second layer on the first layer, the second layer has a roughened surface facing the waveguide, and the air flow channel extends between the roughened surface and the waveguide.

15. The electronic device of claim 1, wherein the optics comprise a first layer mounted to the ring of adhesive and a second layer stacked onto the first layer.

16. The electronic device of claim 15, wherein the air flow channel extends through the first layer and the second layer.

17. The electronic device of claim 15, wherein the air flow channel extends through the first layer but not the second layer, wherein the air flow channel has a first segment that extends through the first layer and a second segment that extends perpendicular from an end of the first segment, the second segment being interposed between the first layer and the second layer.

18. The electronic device of claim 1, further comprising:
an air flow limiting gasket disposed in the air flow channel.

19. An electronic device comprising:
a waveguide configured to propagate first light via total internal reflection;
a tint layer configured to transmit second light to the waveguide;
a peripheral edge seal that couples the waveguide to the tint layer and that laterally extends around an air cavity between the waveguide and the tint layer;
a surface relief grating (SRG) disposed within the air cavity and configured to diffract the first light; and
an opening extending from the air cavity and through the peripheral edge seal, wherein the opening is configured to restrict, in response to an external force applied to the electronic device, air flow out of the air cavity on a time scale less than one second.

20. A display comprising:
a waveguide configured to propagate first light via total internal reflection;
an optical layer configured to transmit second light to the waveguide;
a peripheral edge seal that couples the waveguide to the one or more optical layers and that runs laterally around an air cavity between the waveguide and the optical layer;
a surface relief grating (SRG) disposed within the air cavity and configured to diffract the first light; and
an opening in the optical layer and extending from the air cavity, the opening being configured to trap air within the air cavity on a time scale of an external force applied to the display.
